(19) United States
(12) Patent Application Publication
(10) Pub. No.: US 2026/0369612 A1
(43) Pub. Date: Nov. 19, 2026

(54) HARD CARBON COATED ANODE MATERIAL

(71) Applicant: GM GLOBAL TECHNOLOGY OPERATIONS LLC, Detroit, MI (US)

(72) Inventors: Nathaniel Hardin, Farmington Hills, MI (US); Yifan Zhao, Troy, MI (US); Insun Yoon, Shelby Township, MI (US); Fang Dai, Troy, MI (US)

(73) Assignee: GM GLOBAL TECHNOLOGY OPERATIONS LLC, Detroit, MI (US)

(21) Appl. No.: 19/209,522

(22) Filed: May 15, 2025

(51) Int. Cl. H01M 4/62; H01M 4/02; H01M 4/36; H01M 4/587

(52) U.S. Cl. CPC H01M 4/625; H01M 4/366; H01M 4/587; H01M 2004/027

(57) ABSTRACT

Batteries with hard carbon coated graphite particle anode material and methods for forming such material are provided. A method for forming an anode includes forming a hard carbon layer over graphite particles to form hard carbon coated particles; binding the hard carbon coated particles with binder to form bound hard carbon coated particles; and baking the bound hard carbon coated particles to form the anode.

### INTRODUCTION

The technical field generally relates to rechargeable batteries and more particularly relates to inexpensive methods for making anodes capable of increased charging rates.

High-energy density, electrochemical cells, such as lithium-ion batteries can be used in a variety of consumer products and vehicles, such as Hybrid Electric Vehicles (HEVs) and Electric Vehicles (EVs). Typical lithium-ion and lithium-sulfur batteries include a first electrode, a second electrode, an electrolyte material, and a separator. One electrode serves as a positive electrode or cathode (on discharge) and another serves as a negative electrode or anode (on discharge). A stack of battery cells may be electrically connected to increase overall output. Typical rechargeable lithium-ion batteries operate by reversibly passing lithium-ions back and forth between the negative electrode and the positive electrode. A separator and an electrolyte may be disposed between the negative and positive electrodes. The electrolyte is suitable for conducting lithium-ions and may be in solid (e.g., solid-state diffusion) or liquid form. Lithium-ions move from a cathode (positive electrode) to an anode (negative electrode) during charging of the battery, and in the opposite direction when discharging the battery.

It would be desirable to form electrochemical cells or batteries incorporating negative electrodes/anodes that provide for faster charging, without requiring use of expensive materials to form all of the anode active material. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for forming an anode is provided and includes forming a hard carbon layer over graphite particles to form hard carbon coated particles; binding the hard carbon coated particles with binder to form bound hard carbon coated particles; and baking the bound hard carbon coated particles to form the anode.

In certain embodiments of the method, forming the hard carbon layer over the graphite particles to form the hard carbon coated particles includes: dispersing the graphite particles in a solvent; dissolving an epoxide and at least one of a biopolymer and an acid in the solvent to form a solution, wherein the graphite particles are dispersed in the solution; drying the solution to form a thermoset polymer coating over the graphite particles; and annealing the graphite particles to convert the thermoset polymer coating to hard carbon.

In certain embodiments of the method, dissolving the epoxide and the at least one of a biopolymer and an acid in the solvent to form the solution includes dissolving the epoxide, the biopolymer, and the acid in the solvent to form the solution.

In certain embodiments of the method, the biopolymer is a carbohydrate.

In certain embodiments of the method, the biopolymer is selected from cellulose, derivatives and modified forms of cellulose, such as cellulose acetate, methylcellulose, carboxymethyl cellulose, lignin, and alginate.

In certain embodiments of the method, the epoxide is tetraglycidyl methylene dianiline (TGMDA).

In certain embodiments of the method, the acid is phosphoric acid.

In certain embodiments of the method, the solvent is selected from acetone, acetonitrile, tetrahydrofuran (THF); chloroform; Dichloromethane (DCM); 1,2-Dichloroethane; chlorinated solvents; N-methyl-2-pyrrolidone (NMP); N,N-Dimethylformamide (DMF); ether; and water.

In certain embodiments of the method, annealing the graphite particles to convert the thermoset polymer coating to hard carbon includes annealing the graphite particles at a temperature of from 1000 to 1500 degrees Celsius for a time duration of from 1 to 10 hours.

In certain embodiments of the method, forming the hard carbon layer over the graphite particles to form the hard carbon coated particles includes: dispersing the graphite particles in a solvent; dissolving an epoxide, a biopolymer, and phosphoric acid in the solvent to form a solution, wherein the graphite particles are dispersed in the solution; drying the solution to form a thermoset polymer coating over the graphite particles; and annealing the graphite particles at a temperature of from 1000 to 1500 degrees Celsius for a time duration of from 1 to 10 hours to convert the thermoset polymer coating to hard carbon.

In certain embodiments of the method, dissolving an epoxide, a biopolymer, and phosphoric acid in the solvent includes forming the solution with a biopolymer/epoxide/phosphorous acid ratio of 3/2/3.

In certain embodiments of the method, the epoxide, the biopolymer, and the phosphoric acid include hard carbon precursors, and wherein after dissolving the epoxide, the biopolymer, and the phosphoric acid in the solvent to form the solution, the solution has a graphite/precursors ratio of 5/1.

In another embodiment, a method for forming a hard carbon coating over graphite particles includes: forming a coating over the graphite particles from a carbohydrate-containing precursor, an epoxy-containing precursor, and a phosphorous-containing precursor; and annealing the graphite particles to convert the coating to hard carbon.

In certain embodiments of the method, forming the coating over the graphite particles includes: dispersing the graphite particles in a solvent; dissolving the carbohydrate-containing precursor, the epoxy-containing precursor, and the phosphorous-containing precursor in the solvent to form a solution, wherein the graphite particles are dispersed in the solution; and drying the solution.

In certain embodiments of the method, the phosphorous-containing precursor is phosphoric acid.

In certain embodiments of the method, annealing the graphite particles to convert the coating to hard carbon includes annealing the graphite particles at a temperature of from 1000 to 1500 degrees Celsius for a time duration of from 1 to 10 hours.

In certain embodiments of the method, dissolving the carbohydrate-containing precursor, the epoxy-containing precursor, and the phosphorous-containing precursor in the solvent to form the solution includes forming the solution with a carbohydrate-containing precursor/epoxy-containing precursor/phosphorous-containing precursor ratio of 3/2/3.

In certain embodiments of the method, after dissolving the carbohydrate-containing precursor, the epoxy-containing precursor, and the phosphorous-containing precursor in the solvent to form the solution, wherein the solution has a graphite/precursors ratio of 5/1.

In another embodiment, a battery is provided and includes a cathode; an anode including an anode active material; a separator between the anode and the cathode; and an electrolyte in contact with the anode and the cathode; wherein the anode active material includes hard carbon coated graphite particles.

In certain embodiments of the battery, the hard carbon coated graphite particles are formed by forming a thermoset polymer coating over uncoated graphite particles and performing an anneal process to convert the thermoset polymer coating to hard carbon.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary implementations;

FIG. 2 is a schematic illustrated battery cells in cell groups in a portion of the RESS of FIG. 1;

FIG. 3 is a schematic illustration of a representative battery cell in the vehicle of FIG. 1 that operates in accordance with aspects of the present disclosure;

FIG. 4 is a schematic illustration of a method for forming hard carbon coated graphite particles for use as anode active material for the anode of the battery cell of FIG. 3; and

FIG. 5 is a flowchart illustrating a method for fabricating an anode and for fabricating a battery in accordance with aspects of the present disclosure.

### DETAILED DESCRIPTION

The following detailed description is merely exemplary in nature and is not intended to limit the disclosure or the application and uses thereof. Furthermore, there is no intention to be bound by any theory presented in the preceding introduction or summary or the following detailed description.

For the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

In certain embodiments herein, a “material” structure is a structure that includes, and a structure that is formed of a “material” includes, at least 50 wt. % of the identified material, for example at least 60 wt. % of the identified material, at least 75 wt. % of the identified material, at least 90 wt. % of the identified material, at least 95 wt. % of the identified material, or at least 99 wt. % of the identified material. For example, in certain embodiments, each of a hard carbon coating and a coating formed of hard carbon is a structure that is at least 50 wt. %, at least 60 wt. %, at least 75 wt. %, at least 90 wt. %, at least 95 wt. %, or at least 99 wt. % of hard carbon.

Hard carbon is a promising material for use as anode material in electric vehicle (EV) batteries, as it provides for fast charging. Hard carbon is a type of carbon material, also known as char or non-graphitizing carbon, which cannot be converted to graphite even at high temperatures, and may be used as an anode material in lithium-ion and sodium-ion batteries. Unlike soft carbon (graphitizing carbon), hard carbon resists transformation into the highly ordered graphite structure, even at temperatures as high as 3000 degrees Celsius. Hard carbon has a disordered, amorphous structure with a high proportion of sp3 hybridized carbon atoms. Hard carbon exhibits a low density and extremely high microporosity, which contributes to its suitability for energy storage applications. The disordered structure of hard carbon allows for the intercalation and adsorption of ions (like lithium or sodium) during battery operation, enabling energy storage and release. Hard carbon exhibits high specific surface area and high electrical conductivity.

However, hard carbon is expensive. Embodiments herein provide methods for forming hard carbon coated graphite, and applications for use of hard carbon coated graphite as anode material. Thus, the amount of hard carbon used is reduced compared to completely hard carbon anode material while still providing for fast charging capabilities.

In certain embodiments, methods form hard carbon coated graphite from carbohydrate-containing, epoxy-containing, and phosphorous-containing precursors. In certain embodiments, the carbohydrate-containing precursor is acetyl cellulose, the epoxy-containing precursor is epoxide, and the phosphorous-containing precursor is phosphoric acid.

In certain embodiments, a method for coating graphite particles with hard carbon includes using a solvent to dissolve hard carbon precursors to form a solution, contacting the graphite particles with the solution, drying the solution to form a coating on the graphite particles, and annealing the coated particle to convert the coating thereon to a hard carbon coating.

Embodiments of the present disclosure offer advantages over the existing art, though it is understood that other embodiments may offer different advantages, not all advantages are necessarily discussed herein, and no particular advantage is required for all embodiments.

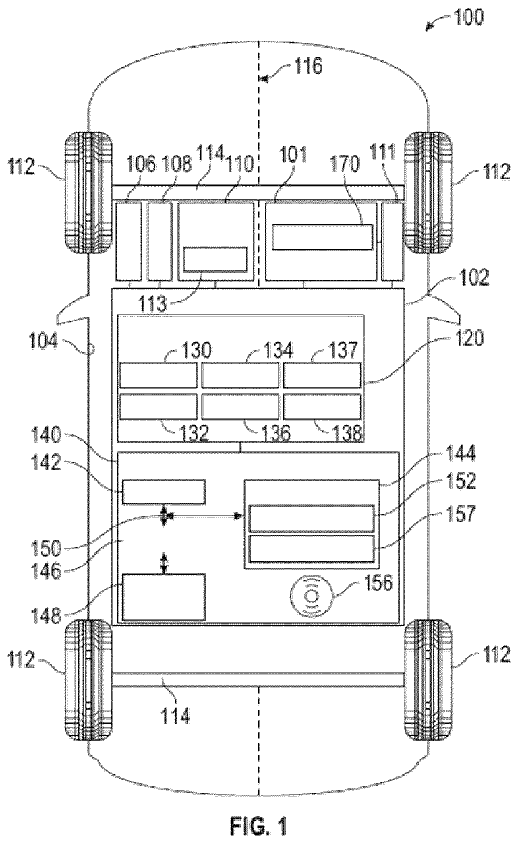

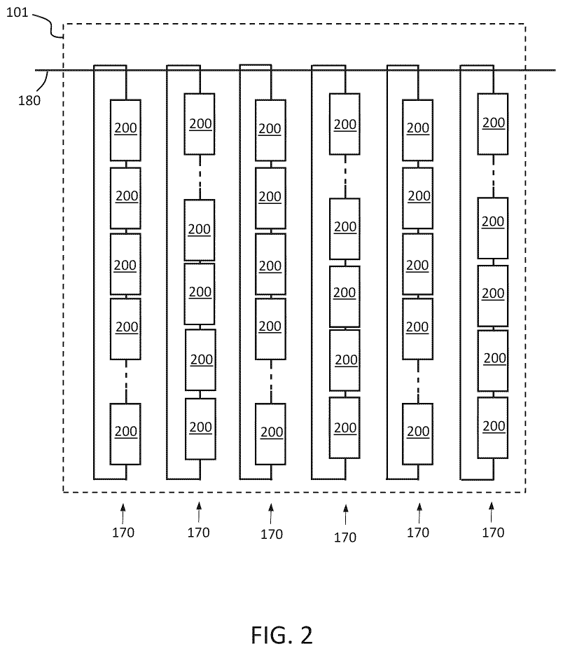

FIG. 1 illustrates a vehicle 100, according to an exemplary implementation. As described in greater detail further below, the vehicle 100 includes, among other components, a rechargeable energy storage system (“RESS”) 101 and a control system 102. In various implementations, the RESS 101 includes a plurality of cell groups 170, for example as depicted in FIG. 2 and described in greater detail further below in connection therewith. Also in various implementations, the control system 102 controls the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, secondary use, home power, non-automotive, and/or other platforms and/or other systems.

In the depicted implementation, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array or arrangement 120 and a control module 140 (or controller), as described in greater detail below.

In various implementations, the sensor array 120 includes various sensors that obtain sensor data of the vehicle 100 for use in controlling, among other functionality, the RESS 101. In the depicted implementation, the sensor array 120 includes one or more voltage sensors 130, current sensors 132, temperature sensors 134, pressure sensors 136, gas sensors 137, and additional sensors 138.

In various implementations, the control module 140 is coupled to the sensor array 120 and receives sensor data therefrom. In various implementations, the control module 140 is further coupled to the RESS 101. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

As depicted in FIG. 1, in various implementations, the control module 140 comprises a computer system, and includes a processor 142, a memory 144, an interface 146, a storage device 148, and a computer bus 150.

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

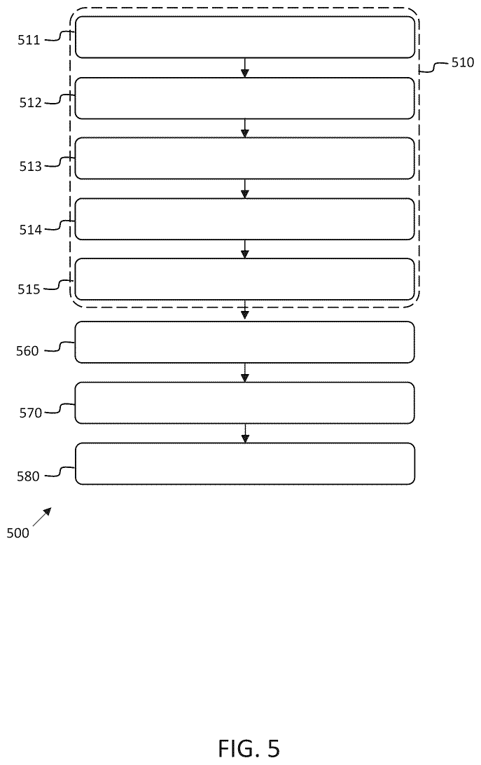

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the method 500 of FIG. 5 and described further below in connection therewith. In another exemplary implementation, the program product may be directly stored in and/or otherwise accessed by the memory 144 and/or a disk (e.g., disk 156), such as that referenced below.

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of a portion of the RESS 101 of FIG. 1, such as a battery module 101. As shown, the battery module includes a plurality of cell groups 170, in accordance with exemplary implementations.

As depicted in FIG. 2, in various implementations, the battery module 101 includes a number of cell groups 170. In certain embodiments, the cell groups 170 are connected in series via bus bar 180. The cells group may be configured electrically in series as shown and/or in parallel. It will be appreciated that the number and configuration of cell groups 170 may vary in different implementations, and the subject matter described herein is not limited to any particular number, type or configuration of cell groups 170. The bus bar 180 may be connected to the drive system 110.

In certain embodiments, each cell group 170 may include one or more battery cells 200 or other energy storage elements. As shown the battery cells 200 may be arranged in a stack, such that the cell groups 170 are referred to as cell stacks 170. The battery cells 200 may be configured electrically in series or in parallel to provide a desired DC voltage level and/or DC output current. While each cell group 170 is illustrated as including five battery cells 200, the number of battery cells 200 per cell group 170 may be any desired suitable number.

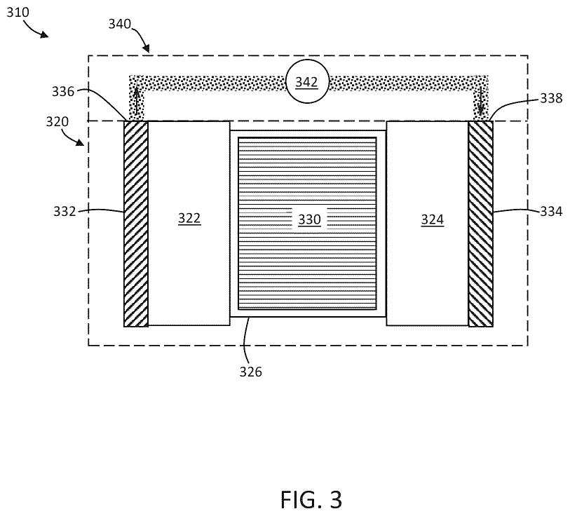

Presented in FIG. 3 is an exemplary electrochemical device in the form of a rechargeable battery 310, that powers a desired electrical load, such as vehicle 10 of FIG. 1, and offers fast charging capabilities, such as DCFC. Battery 310 includes a pair of electrically conductive electrodes, namely a first (negative or anode) working electrode 322 and a second (positive or cathode) working electrode 324, packaged inside a protective outer housing 320. In at least some configurations, the battery housing 320 may be an envelope-like pouch that is formed of aluminum foil or other suitable sheet material. Both sides of a metallic pouch may be coated with a polymeric finish to insulate the metal from the internal cell elements and from adjacent cells, if any. Alternatively, the battery housing (or “cell casing”) 320 may take on a cylindrical metal can configuration, i.e., for cylindrical battery cell configurations, or a polyhedral metal box configuration, i.e., for prismatic battery cell configurations. Reference to either working electrode 322, 324 as an “anode” or “cathode” or, for that matter, as “positive” or “negative” does not limit the electrodes 322, 324 to a particular polarity as the system polarity may change depending on whether the battery 310 is being operated in a charge mode or a discharge mode. Although FIG. 3 illustrates a single battery cell unit, such as a battery cell 200 of FIG. 2, inserted within the battery housing 320, it should be appreciated that the housing 320 may stow therein a stack of multiple cell units (e.g., five to five thousand cells or more), such as stack 170 of FIG. 2.

With continuing reference to FIG. 3, anode electrode 322 may be fabricated with an active anode electrode material that is capable of incorporating ions during a battery charging operation and releasing ions during a battery discharging operation.

In embodiments herein, the anode electrode 322 is formed from active anode electrode material in the form of hard carbon coated graphite particles.

Disposed inside the battery housing 320 between the two electrodes 322, 324 is a porous separator 326, which may be in the nature of a microporous or nanoporous polymeric separator. The porous separator 326 may include a non-aqueous fluid electrolyte composition and/or solid electrolyte composition, collectively designated 330, which may also be present in the negative electrode 322 and the positive electrode 324. A negative electrode current collector 332 may be positioned on or near the negative electrode 322, and a positive electrode current collector 334 may be positioned on or near the positive electrode 324. The negative electrode current collector 332 and positive electrode current collector 334 respectively collect and move free electrons to and from an external circuit 340. An interruptible external circuit 340 with a load 342 connects to the negative electrode 322, through its respective current collector 332 and electrode tab 336, and to the positive electrode 324, through its respective current collector 334 and electrode tab 338. Current collectors 332 and 334 may be formed from aluminum, copper or another suitable material. Separator 326 may be a sheet-like structure that is composed of a porous polyolefin membrane, e.g., with a porosity of about 35% to 65% and a thickness of approximately 25 to 30 microns. Electrically non-conductive ceramic particles (e.g., silica) may be coated onto the porous membrane surfaces of the separators 326.

The porous separator 326 may operate as both an electrical insulator and a mechanical support structure by being sandwiched between the two electrodes 322, 324 to prevent the electrodes from physically contacting each other and, thus, the occurrence of a short circuit. In addition to providing a physical barrier between the electrodes 322, 324, the porous separator 326 may provide a minimal resistance path for internal passage of ions (and related anions) during cycling of the ions to facilitate functioning of the battery 310. For some optional configurations, the porous separator 326 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage system (RESS), battery 310 generates electric current that is transmitted to one or more loads 342 operatively connected to the external circuit 340. While the load 342 may be any number of electrically powered devices, a few non-limiting examples of power-consuming load devices include an electric motor for a hybrid or full-electric vehicle, a laptop or tablet computer, a cellular smartphone, cordless power tools and appliances, portable power stations, etc. The battery 310 may include a variety of other components that, while not depicted herein for simplicity and brevity, are nonetheless readily available. For instance, the battery 310 may include one or more gaskets, terminal caps, tabs, battery terminals, and other commercially available components or materials that may be situated on or in the battery 310. Moreover, the size and shape and operating characteristics of the battery 310 may vary depending on the particular application for which it is designed.

### Negative Electroactive Material/Active Anode Material

Anode electrode 322 may be fabricated with a negative electroactive material, i.e., an active anode electrode material that is capable of supplying ions during a battery discharging operation and incorporating ions during a battery charging operation. In embodiments herein, the anode electrode material is or includes hard carbon coated graphite particles.

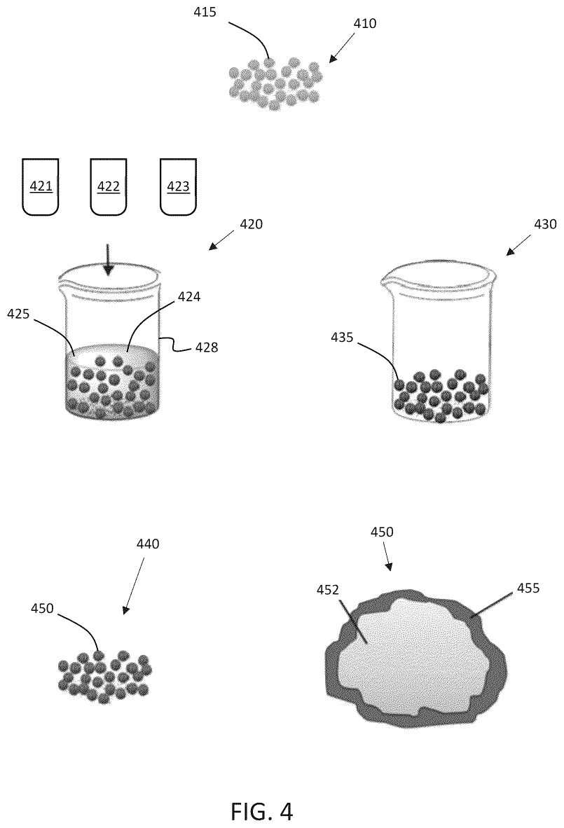

Referring to FIG. 4, formation of the hard carbon coated graphite particles is illustrated.

As shown, graphite particles 415 are provided at a processing stage 410. In certain embodiments, the graphite particles 415 may be artificial or synthetic. Artificial or synthetic graphite is a material consisting of graphitic carbon which may be obtained by graphitizing of non-graphitic carbon, by chemical vapor deposition (CVD) from hydrocarbons at temperatures above 2500 degrees K, by decomposition of thermally unstable carbides, by crystallizing from metal melts supersaturated with carbon, or by other suitable processes.

At processing stage 420, the graphite particles 415 are dispersed in a solvent 424 in a container 428. In certain embodiments, the solvent 424 may be selected from acetone, acetonitrile, tetrahydrofuran (THF); chloroform; Dichloromethane (DCM); 1,2-Dichloroethane; chlorinated solvents including trichloroethylene (TCE), tetrachloroethylene (PCE), 1,1,1-trichloroethane (TCA), and methylene chloride; N-methyl-2-pyrrolidone (NMP); N,N-Dimethylformamide (DMF); ether; and water.

At processing stage 420, a first component 421 may be dissolved in the solvent 424. The first component 421 may be an epoxide or epoxy-precursor. In certain embodiments, the first component 421 may be selected from tetraglycidyl methylene dianiline (TGMDA), Bisphenol A (BPA), glycidol (oxiran-2-yl)methanol); ethylene oxide (oxirane); propylene oxide (2-methyloxirane); or other suitable epoxide or epoxy precursors.

At processing stage 420, an optional second component 422 may be dissolved in the solvent 424. In certain embodiments, the second component 422 is an acid. In certain embodiments, the second component 422 is a phosphorous-containing precursor. For example, the second component 422 may be phosphoric acid.

At processing stage 420, an optional third component 423 may be dissolved in the solvent 424. In certain embodiments, the third component 423 is a biopolymer. In certain embodiments, the third component 423 is a carbohydrate. In certain embodiments, the third component 423 is selected from cellulose, derivatives and modified forms of cellulose, such as cellulose acetate, methylcellulose, carboxymethyl cellulose, lignin, and alginate, or other suitable material.

At processing stage 420, the first component 421 and at least one of the second component 422 and the third component 423 are dissolved in the solvent 424 to form a solution 425. In certain embodiments, the first component 421, the second component 422, and the third component 423 are dissolved in the solvent 424 to form a solution 425.

For example, the first component 421, the second component 422, and the third component 423 may be dissolved in the solvent 424 to form a solution 425 with a first component/second component/third component ratio of from 3/2/3.

For example, the solution 425 may be formed with from 5 to 10 parts of the first component 421, from 2 to 8 parts of the second component 422, and from 5 to 10 parts of the third component 423.

In certain embodiments, the amount of the first component 421 is greater than the amount of the second component 422. In certain embodiments, the amount of the third component 423 is greater than the amount of the second component 422. In certain embodiments, the amount of the first component 421 is equal to the amount of the third component 423.

It is noted that the solution 425 may be formed before or after the graphite particles 415 are fed into the container 428.

In the method, the graphite particles 415 are dispersed in the solvent 424 and/or in the solution 425. For example, at processing stage 420, the solvent 424 and the particles 415 may be stirred or the solution 425 and particles 415 may be stirred. Stirring may be performed continuously while adding the particles 415 and components 421-423.

Further, the weight ratio of components 421-423 to graphite particles 415 may be from 1/10 to 1/2, such as from 1/8 to 1/3, for example 1/5. In other words, the components 421-423 may form 20% by weight of the graphite particles 415 and the solution 425 may have a graphite/precursors ratio of 5/1.

In the solution, the epoxide may introduce cross-linking points in the cellulose structure, which can enhance the stability and properties of the resulting carbon material. When formed as the solution, the acid may hydrolyze and decrystallize the cellulose, making it more accessible for chemical reactions. The acid may catalyze the reaction of epoxides with cellulose, accelerating the cross-linking process and potentially influencing the final structure of the hard carbon. Further, the acid may promote the formation of chemical bonds between cellulose chains, creating a network structure. The cross-linked structure, when subjected to carbonization (heating), can lead to the formation of pores within the material, enhancing its surface area and capacity for ion storage.

At processing stage 430, a drying process is performed such that the solvent evaporates and the dissolved components 421, 422, and 423 form an intermediate coating 435 over the particles 415. For example, the intermediate coating 435 may be a thermoset polymer coating.

At processing stage 440, an annealing process is performed to convert the intermediate coating 435 to a hard carbon coating 452 to form the hard carbon coated graphite particles 450. A cross-sectional view of a hard carbon coated graphite particle 450 is shown to illustrate the artificial graphite core 451 encapsulated by the hard carbon coating 452.

In certain embodiments, each hard carbon coated particle 450 is at least 5 weight percent hard carbon, such as at least 10 weight percent hard carbon, at least 15 weight percent hard carbon, at least 20 weight percent hard carbon, at least 25 weight percent hard carbon, at least 30 weight percent hard carbon, at least 35 weight percent hard carbon, at least 40 weight percent hard carbon, at least 45 weight percent hard carbon, at least 50 weight percent hard carbon, at least 55 weight percent hard carbon, at least 60 weight percent hard carbon, at least 65 weight percent hard carbon, at least 70 weight percent hard carbon, at least 75 weight percent hard carbon, at least 80 weight percent hard carbon, at least 85 weight percent hard carbon, at least 90 weight percent hard carbon, or at least 95 weight percent hard carbon.

In certain embodiments, each hard carbon coated particle 450 is at most 10 weight percent hard carbon, such as at most 15 weight percent hard carbon, at most 20 weight percent hard carbon, at most 25 weight percent hard carbon, at most 30 weight percent hard carbon, at most 35 weight percent hard carbon, at most 40 weight percent hard carbon, at most 45 weight percent hard carbon, at most 50 weight percent hard carbon, at most 55 weight percent hard carbon, at most 60 weight percent hard carbon, at most 65 weight percent hard carbon, at most 70 weight percent hard carbon, at most 75 weight percent hard carbon, at most 80 weight percent hard carbon, at most 85 weight percent hard carbon, at most 90 weight percent hard carbon, or at most 95 weight percent hard carbon.

The anneal process may be performed at a temperature of from 1000 to 1500 degrees Celsius for a time duration of from 1 to 10 hours. For example, the annealing process may be performed at a temperature of from 1100 to 1300 degrees Celsius, such as at 1200 degrees Celsius.

### Positive Electroactive Material/Active Cathode Material

Cathode electrode 324 may be fabricated with a positive electroactive material, i.e., an active cathode electrode material that is capable of supplying ions during a battery charging operation and incorporating ions during a battery discharging operation. The cathode electrode 324 material may include, for instance, lithium transition metal oxide, phosphate, or silicate, such as LiMO₂ (M=Co, Ni, Mn, or combinations thereof); LiM₂O₄ (M=Mn, Ti, or combinations thereof), LiMPO₄ (M=Fe, Mn, Co, or combinations thereof), and LiMₓM′₂₋ₓO₄ (M, M′=Mn or Ni). Additional examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides. The active cathode electrode material may also be or include sulfur/carbon composite material. For example, the active cathode electrode material may include sulfur located in porous carbon shells, which may be optionally coated with a polymer including nitrogen atoms. Other composite material structures may be suitable. In certain embodiments, the active cathode electrode material is selected from a sulfur/carbon composite material, lithium iron phosphate (LFP), lithium ion manganese oxide (LMO), lithium manganese (LMN), nickel cobalt manganese aluminum (NCMA), and/or a combination thereof.

### Electrically Conductive Material

In embodiments herein, the anode and/or cathode electrode 322/324 may also include, in addition to the active electrode material, an additional electrically conductive material. The electrically conductive material may be selected from carbon-based materials, powdered nickel or other metal particles, or a conductive polymer. Carbon-based materials may include, for example, particles of graphite, acetylene black (such as DENKA™ black), carbon black (such as KETJEN™ black and/or Super C45 or C65), carbon fibers and nanotubes such as single-wall carbon nanotubes, graphene, graphene nanoplatelets, or other suitable conductive material. Examples of a conductive polymer include polyaniline, polythiophene, polyacetylene, polypyrrole, and the like.

### Binder

In embodiments herein, the anode and/or cathode electrode may also include a binder material. In certain embodiments, the binder material is selected from styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose, hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid, polyacrylate, polymethacrylic acid, polymethacrylate, polyacrylamide, polyurethane, fluorinated polymer, chlorinated polymer, polyvinylidene fluoride, poly(vinylidene fluoride)-hexafluoropropene, and combinations thereof. For example, the binder material may be polyacrylic acid (PAA), polyvinyl pyrrolidone (PVP), polyvinyl alcohol (PVA), carboxymethyl cellulose (CMC) and styrene-butadiene rubber (SBR), carbohydrates, latex, and/or a combination thereof.

### Dispersant

The anode and/or cathode electrode may also include a dispersant, such as an amphiphilic dispersant. As described below, electrodes may be formed from a slurry. In embodiments herein, the slurry is aqueous. In order to form a high quality coating from the slurry the binder must be dispersed throughout the aqueous slurry. Therefore, the dispersant is provided in the slurry. In certain embodiments herein, the dispersant has an alkyl-attached functional group and an ionic-based functional group.

### Electrode Composition

In certain embodiments, the anode and/or cathode electrode includes from 80 to 99.5 weight percent of the respective active electrode material, including all values and ranges therein. For example, either or both electrodes may include at least 80, at least 85, at least 90, at least 95, at least 96, at least 97, at least 98, or at least 99 weight percent of active electrode material based on a total weight of the respective electrode. Further, either or both electrodes may include at most 85, at most 90, at most 95, at most 96, at most 97, at most 98, at most 99, or at most 99.5 weight percent of active electrode material based on a total weight of the respective electrode.

In certain embodiments, the anode and/or cathode electrode includes from 0.1 to 10 weight percent of the additional electrically conductive material (if present), based on a total weight of the respective electrode, including all values and ranges therein.

In certain embodiments, either or both electrodes include from 0.1 to 10 weight percent of binder based on a total weight of the respective electrode, including all values and ranges therein.

In certain embodiments, either or both electrodes include from 0.1 to 5 weight percent of dispersant based on a total weight of the respective electrode, including all values and ranges therein.

FIG. 5 is a flow chart illustrating a method 500 for making a battery, like the battery described above. As shown, method 500 may include forming an anode at operation 510.

Operation 510 may include preparing an anode slurry at operation 511. Operation 511 may include concurrently or consecutively adding anode electroactive material in the form of hard carbon coated graphite particles, one or more binders, optionally, one or more electrically conductive materials, and optionally a polymer dispersant to water to form a combination.

Operation 510 may include milling the combination with a mixer at operation 512. The mixer may be a planetary, high-speed, acoustic, static mixer, extruder and dissolver. Milling may be performed for a suitable time period and at a suitable speed, and the combination may be maintained at about ambient or room temperature (e.g., greater than or equal to about 15 °C to less than or equal to about 40 °C) during the milling process. In certain embodiments, the slurry may be mixed at a rate of from 500 to 3000 rpm for a duration of from two to ten minutes. After mixing, the slurry is a homogeneous mixture, i.e., the slurry has a substantially homogenous consistency. In other words, each constituent is dispersed evenly throughout the slurry.

After preparing the anode slurry, operation 510 may further include, at operation 513, contacting the anode material slurry with one or more surfaces of a negative electrode current collector. The contacting may include coating the one or more surfaces of the negative electrode current collector using, for example, a doctor blade or an automatic coater, by way of non-limiting example.

As shown, operation 510 may further include drying the as-applied slurry to form an electroactive material layer on or adjacent to the one or more surfaces of the current collector at operation 514, such as by baking. In certain variations, drying may include heating the current collector and electroactive material layer to about 70 °C. While drying, the temperature may be maintained at no higher than 200 °C.

Operation 510 may also include, at operation 515, calendaring the electroactive material layer at room temperature to form an electroactive material layer having a porosity greater than or equal to about 25 vol. % to less than or equal to about 50 vol. %, and in certain aspects, greater than or equal to 25 vol. % to less than or equal to 50 vol. %.

After calendaring the layer of slurry, processing of the layer is complete and the anode electrode 322 is formed. Thus, method 500 may be considered to include at 510, forming the anode from the slurry, which incorporates forming the slurry, applying the layer, drying the layer, and calendaring the layer.

After forming the anode electrode 322, method 500 continues at operation 560 with assembling the battery 310 and cells thereof. For example, anode electrode 322 and collector 332 may be positioned in battery housing 320 and spaced apart from cathode electrode 324 and current collector 334 by porous separator 326 and in contact with electrolyte composition 330.

Thereafter, method 500 may include, at operation 570, performing a cycle of charge and discharge processes. Thereafter, method 500 may include, at operation 580, operating a device, such as vehicle 10, with power from the battery.

It will be appreciated that the batteries, vehicles, and methods may vary from those depicted in the Figures and described herein. It will similarly be appreciated that the operations of the methods may differ from that depicted in the Figures, and/or that various operations of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for forming an anode, the method comprising:
forming a hard carbon layer over graphite particles to form hard carbon coated particles;
binding the hard carbon coated particles with binder to form bound hard carbon coated particles; and
baking the bound hard carbon coated particles to form the anode.

2. The method of claim 1, wherein forming the hard carbon layer over the graphite particles to form the hard carbon coated particles comprises:
dispersing the graphite particles in a solvent;
dissolving an epoxide and at least one of a biopolymer and an acid in the solvent to form a solution, wherein the graphite particles are dispersed in the solution;
drying the solution to form a thermoset polymer coating over the graphite particles; and
annealing the graphite particles to convert the thermoset polymer coating to hard carbon.

3. The method of claim 2, wherein dissolving the epoxide and the at least one of a biopolymer and an acid in the solvent to form the solution comprises dissolving the epoxide, the biopolymer, and the acid in the solvent to form the solution.

4. The method of claim 3, wherein the biopolymer is a carbohydrate.

5. The method of claim 3, wherein the biopolymer is selected from cellulose, derivatives and modified forms of cellulose, such as cellulose acetate, methylcellulose, carboxymethyl cellulose, lignin, and alginate.

6. The method of claim 3, wherein the epoxide is tetraglycidyl methylene dianiline (TGMDA).

7. The method of claim 3, wherein the acid is phosphoric acid.

8. The method of claim 3, wherein the solvent is selected from acetone, acetonitrile, tetrahydrofuran (THF); chloroform; Dichloromethane (DCM); 1,2-Dichloroethane; chlorinated solvents; N-methyl-2-pyrrolidone (NMP); N,N-Dimethylformamide (DMF); ether; and water.

9. The method of claim 3, wherein annealing the graphite particles to convert the thermoset polymer coating to hard carbon comprises annealing the graphite particles at a temperature of from 1000 to 1500 degrees Celsius for a time duration of from 1 to 10 hours.

10. The method of claim 1, wherein forming the hard carbon layer over the graphite particles to form the hard carbon coated particles comprises:
dispersing the graphite particles in a solvent;
dissolving an epoxide, a biopolymer, and phosphoric acid in the solvent to form a solution, wherein the graphite particles are dispersed in the solution;
drying the solution to form a thermoset polymer coating over the graphite particles; and
annealing the graphite particles at a temperature of from 1000 to 1500 degrees Celsius for a time duration of from 1 to 10 hours to convert the thermoset polymer coating to hard carbon.

11. The method of claim 10, wherein dissolving an epoxide, a biopolymer, and phosphoric acid in the solvent comprises forming the solution with a biopolymer/epoxide/phosphorous acid ratio of 3/2/3.

12. The method of claim 11, wherein the epoxide, the biopolymer, and the phosphoric acid comprise hard carbon precursors, and wherein after dissolving the epoxide, the biopolymer, and the phosphoric acid in the solvent to form the solution, the solution has a graphite/precursors ratio of 5/1.

13. A method for forming a hard carbon coating over graphite particles, the method comprising:
forming a coating over the graphite particles from a carbohydrate-containing precursor, an epoxy-containing precursor, and a phosphorous-containing precursor; and
annealing the graphite particles to convert the coating to hard carbon.

14. The method of claim 13, wherein forming the coating over the graphite particles comprises:
dispersing the graphite particles in a solvent;
dissolving the carbohydrate-containing precursor, the epoxy-containing precursor, and the phosphorous-containing precursor in the solvent to form a solution, wherein the graphite particles are dispersed in the solution; and
drying the solution.

15. The method of claim 14, wherein the phosphorous-containing precursor is phosphoric acid.

16. The method of claim 15, wherein annealing the graphite particles to convert the coating to hard carbon comprises annealing the graphite particles at a temperature of from 1000 to 1500 degrees Celsius for a time duration of from 1 to 10 hours.

17. The method of claim 16, wherein:
dissolving the carbohydrate-containing precursor, the epoxy-containing precursor, and the phosphorous-containing precursor in the solvent to form the solution comprises forming the solution with a carbohydrate-containing precursor/epoxy-containing precursor/phosphorous-containing precursor ratio of 3/2/3.

18. The method of claim 17, wherein after dissolving the carbohydrate-containing precursor, the epoxy-containing precursor, and the phosphorous-containing precursor in the solvent to form the solution, wherein the solution has a graphite/precursors ratio of 5/1.

19. A battery comprising:
a cathode;
an anode comprising an anode active material;
a separator between the anode and the cathode; and
an electrolyte in contact with the anode and the cathode;
wherein the anode active material comprises hard carbon coated graphite particles.

20. The battery of claim 19, wherein the hard carbon coated graphite particles are formed by forming a thermoset polymer coating over uncoated graphite particles and performing an anneal process to convert the thermoset polymer coating to hard carbon.
